(19) United States
(12) Patent Application Publication
(10) Pub. No.: US 2007/0115596 A1
(43) Pub. Date: May 24, 2007

(54) MAGNETIC DETECTING ELEMENT HAVING PINNED MAGNETIC LAYER WITH PINNED MAGNETIZATION DIRECTION AND FREE MAGNETIC LAYER FORMED ON PINNED MAGNETIC LAYER WITH NONMAGNETIC MATERIAL LAYER INTERPOSED BETWEEN WITH MAGNETIZATION DIRECTION CHANGING BY EXTERNAL MAGNET

(75) Inventors: Ryo Nakabayashi, Niigata-ken (JP); Yosuke Ide, Niigate-ken (JP); Masamichi Saito, Niigata-ken (JP); Naoya Hasegawa, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/561,339

(22) Filed: Nov. 17, 2006

(30) Foreign Application Priority Data
Nov. 21, 2005 (JP) 2005-335750

(51) Int. Cl. G11B 5/33

(52) U.S. Cl. 360/324; 360/324.11; 360/324.12

(57) ABSTRACT

A magnetic detecting element and method of manufacturing the same are provided. The magnetic detecting element including a free magnetic layer and a second pinned magnetic layer is formed of a CoMnGeSi alloy layer represented by a composition formula of Co₂ₓMnₓ(Ge_{1-z}Si_{z})_{y} (where x and y are atomic percent, and 3x+y=100 atomic percent). The content y in the composition formula is 23 atomic percent to 26 atomic percent, and a Si ratio Z in GeSi is 0.1 to 0.6. Accordingly, ΔRA identical with a case when a CoMnGe alloy is used can be obtained, and a coupling magnetic field Hin or a coercive force Hc can be reduced.

This application claims the benefit of Japanese Patent Application No. 2005-335750 filed Nov. 21, 2005, which is hereby incorporated by reference.

### BACKGROUND

1. Field

The present embodiments relate to a magnetic detecting element.

2. Related Art

In JP-A-2003-218428 (U.S. Pub. No. 2003137785A1) and JP-A-2005-116703 (U.S. Pub. No. 2005073778A1), a CPP-type magnetic detecting element that has a pinned magnetic layer or a free magnetic layer formed of a Heusler alloy, such as a CoMnGe alloy (atomic ratio is Co:Mn:Ge=2:1:1) or a CoMnSi alloy (atomic ratio is Co:Mn:Si=2:1:1), is disclosed.

If the free magnetic layer and the pinned magnetic layer are formed of the Heusler alloy, such as the CoMnGe alloy or the like, spin polarizability can be increased compared with a CoFe alloy or NiFe alloy, and thus the amount of a change in magnetoresistance ΔR can be increased. In the CPP-type magnetic detecting element, an increase of a product of the amount of the change in magnetoresistance ΔR and an element area A, which is ΔRA, is a very important parameter for high recording density. It is preferable to use the Heusler alloy for the free magnetic layer or the pinned magnetic layer.

In JP-A-2003-218428 and JP-A-2005-116703, various compositions of the Heusler alloy are disclosed. However, in the experiments of JP-A-2003-218428 or JP-A-2005-116703, a CoMnGe alloy or a CoMnSi alloy is used as the Heusler alloy, and the experimental result of a Heusler alloy of a quaternary system is not disclosed.

According to an experiment described below, it can be seen that, when the free magnetic layer and the pinned magnetic layer (in an experiment described below, the second pinned magnetic layer) are formed of the CoMnGe alloy, a coupling magnetic field Hin formed between the pinned magnetic layer and the free magnetic layer and a coercive force Hc of the free magnetic layer are increased. The reduction of the coupling magnetic field Hin is important to favorably maintain an asymmetry, to reduce Barkhausen noise, and to increase an S/N ratio. The reduction of the coercive Hc of the free magnetic layer is important to reduce a variation in reproduction output.

According to the experiment described below, it can be seen that, when the free magnetic layer and the pinned magnetic layer (in the experiment described below, the second pinned magnetic layer) are formed of a CoMnSi alloy, ΔRA is small compared with a case where the CoMnGe alloy is used, the coercive force Hc of the free magnetic layer is increased, and a unidirectional exchange bias magnetic field (Hex*) is small.

The unidirectional exchange bias magnetic filed (Hex*) is the strength of a magnetic field including an exchange coupling magnetic field formed between the pinned magnetic layer and an antiferromagnetic layer or a coupling magnetic field by an RKKY interaction between magnetic layers when the pinned magnetic layer has a laminated ferrimagnetic structure. If the unidirectional exchange bias magnetic field (Hex*) is small, a pinned force of magnetization of the pinned magnetic layer is weak, which causes deterioration of reproduction characteristics.

### SUMMARY OF THE INVENTION

The present embodiments may obviate one or more of the drawbacks of the related art. For example, in one embodiment, a magnetic detecting element maintains a high ΔRA and reduces a coupling magnetic field Hin or a coercive force Hc.

In one embodiment, a magnetic detecting element includes a pinned magnetic layer in which a pinned magnetization direction is pinned, and a free magnetic layer that is formed on the pinned magnetic layer with a nonmagnetic material layer interposed therebetween and in which a magnetization direction is changed by an external magnetic field. The free magnetic layer, the pinned magnetic layer, or the free magnetic layer and the pinned magnetic layer have a CoMnGeSi alloy layer represented by a composition formula Co₂ₓMnₓ(Ge_{1-z}Si_{z})_{y} (where x and y are atomic percent, and 3x+y=100 atomic percent). In one embodiment, the content y is about 23 atomic percent to about 26 atomic percent, and a Si ratio Z in GeSi is about 0.1 to 0.6.

In one embodiment, it can be seen that ΔRA identical with a case where a CoMnGe alloy is used can be obtained, and a coupling magnetic field Hin or a coercive force Hc can be reduced. In one embodiment, a unidirectional exchange bias magnetic field (Hex*) can also be increased equal to a case where a CoMnGe alloy is used.

In one embodiment, the magnetic detecting element can appropriately cope with high recording density. A variation in reproduction output can be reduced, and asymmetry can be maintained. In addition, Barkhausen noise can be reduced, and an S/N ratio can be increased.

In one embodiment of the magnetic detecting element, the Si ratio Z may be about 0.4 or less. Accordingly, ΔRA and the unidirectional exchange bias magnetic field (Hex*) can be appropriately increased. The coercive force Hc can be appropriately reduced.

In one embodiment of the magnetic detecting element, the Si ratio Z may be about 0.25 or more. The coupling magnetic field Hin and the coercive force Hc can be appropriately reduced.

In one embodiment of the magnetic detecting element, the CoMnGeSi alloy layer may be formed close to at least the nonmagnetic material layer. The coupling magnetic field Hin can be reduced.

In one embodiment, the free magnetic layer or the pinned magnetic layer is formed of the CoMnGeSi alloy layer that has a predetermined composition ratio. In this embodiment, a ΔRA identical with a case where the free magnetic layer or the pinned magnetic layer is formed of a CoMnGe alloy can be obtained, and the coupling magnetic field Hin or the coercive force Hc of the free magnetic layer can be reduced. The unidirectional exchange bias magnetic field (Hex*) can also be increased equal to a case where the free magnetic layer or the pinned magnetic layer is formed of a CoMnGe alloy.

The magnetic detecting element according to one embodiment can cope with high recording density. A variation in reproduction output can be reduced, and asymmetry can be favorably maintained. In addition, Barkhausen noise can be reduced, and an S/N ratio can be increased.

### BRIEF DESCRIPTION OF THE DRAWINGS

FIG. 1 a partial cross-sectional view that shows one embodiment of a cut surface when a CPP-type dual spin-valve thin film element (magnetic detecting element) is cut from a direction parallel to a surface that faces a recording medium;

FIG. 2 a partial cross-sectional view that shows one embodiment of a cut surface when a CPP-type single spin-valve thin film element (magnetic detecting element) is cut from a direction parallel to a surface that faces a recording medium;

FIG. 3 is a graph that exemplifies the relationship between the content y of GeSi of a magnetic detecting element containing CoMnGeSi and ΔRA and the relationship between the content w of Ge of a magnetic detecting element containing CoMnGe and ΔRA;

FIG. 4 is a graph that exemplifies the relationship between the content y of GeSi of a magnetic detecting element containing CoMnGeSi and a coercive force Hc and the relationship between the content w of Ge of a magnetic detecting element containing CoMnGe and the coercive force Hc;

FIG. 5 is a graph that exemplifies the relationship between the content y of GeSi of a magnetic detecting element containing CoMnGeSi and a coupling magnetic field Hin and the relationship between the content w of Ge of a magnetic detecting element containing CoMnGe and a coupling magnetic field Hin;

FIG. 6 is a graph that exemplifies the relationship between a Si ratio Z of a magnetic detecting element containing CoMnGeSi and ΔRA;

FIG. 7 is a graph that exemplifies the relationship between a Si ratio Z of a magnetic detecting element containing CoMnGeSi and a coercive force Hc of a free magnetic layer; and

FIG. 8 is a graph that exemplifies the relationship between a Si ratio Z of a magnetic detecting element containing CoMnGeSi and a coupling magnetic field Hin.

### DETAILED DESCRIPTION

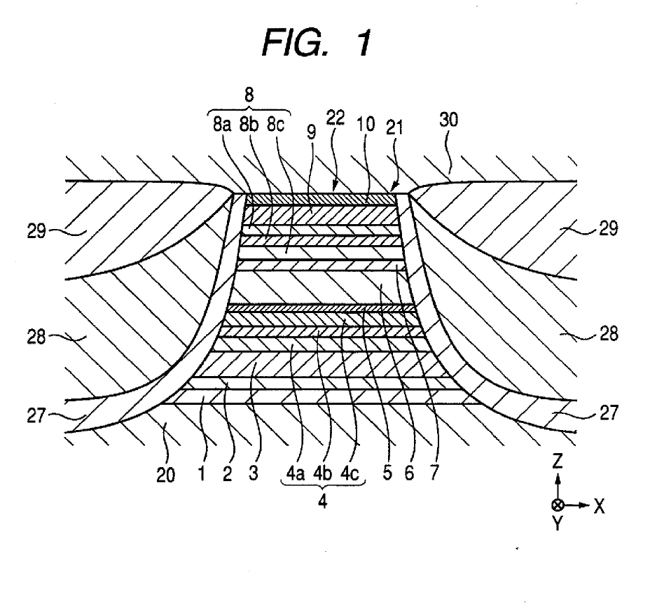

FIG. 1 is a partial cross-sectional view that shows one embodiment of a CPP-type dual spin-valve thin film element (magnetic detecting element).

In one embodiment, as shown in FIG. 1, a dual spin-valve thin film element is provided at a trailing end of a floating slider provided in a hard disk device so as to detect a recording magnetic field of a hard disk or the like. In FIG. 1, the X direction is a track width direction, the Y direction is a direction of a leak magnetic field from a magnetic recording medium (height direction), and the Z direction is a moving direction of a magnetic recording medium, such as a hard disk or the like, and a lamination direction of individual layers of the single spin-valve thin film element. Each direction is perpendicular to the other two directions.

In one embodiment, as shown in FIG. 1, a dual spin-valve thin film element 21 is formed on a lower shield layer 20. The dual spin-valve thin film element 21 has a laminate 22.

The laminate 22 has a base layer 1, a seed layer 2, a lower antiferromagnetic layer 3, a lower pinned magnetic layer 4, a lower nonmagnetic material layer 5, a free magnetic layer 6, an upper nonmagnetic material layer 7, an upper pinned magnetic layer 8, an upper antiferromagnetic layer 9, and a protective layer 10 that are laminated in that order from the below.

In one embodiment, the magnetization of the free magnetic layer 6 is aligned with the track width direction (in the drawing, the X direction), The magnetization of the pinned magnetic layers 4 and 8 is pinned in a direction parallel to the height direction (in the drawing, the Y direction). In this embodiment, the pinned magnetic layers 4 and 8 have a laminated ferrimagnetic structure. The magnetization of the first pinned magnetic layers 4a and 8a and the magnetization of the second pinned magnetic layers 4c and 8c are antiparallel to each other.

The laminate 22 is formed in an approximately trapezoidal shape in which the width in the track width direction (in the drawing, the X direction) gradually decreases from its lower side toward its upper side.

On both sides of the laminate 22 in the track width direction, an insulating layer 27, a hard bias layer 28, and an insulating layer 29 are laminated in the order from the below. An upper shield layer 30 is formed of a magnetic material on the insulating layer 29 and the protective layer 10. In the CPP-type spin-valve thin film element, the lower shield layer 20 and the upper shield layer 30 serve as electrodes, and is a current source that flows the current in a direction perpendicular to interfaces of the individual layers constituting the laminate 22 (a direction parallel to the Z direction in the drawing).

In one embodiment, the base layer 1 is formed of a nonmagnetic material, such as at least one element selected from the group of, for example, Ta, Hf, Nb, Zr, Ti, Mo, or W. The seed layer 2 is formed of, for example, NiFeCr or Cr. If the seed layer 2 is formed of NiFeCr, the seed layer 2 has a face-centered cubic (fcc) structure, in which equivalent crystal planes represented as [111] planes are preferentially oriented in a direction parallel to the surface of the seed layer 2. If the seed layer 2 is formed of Cr, the seed layer 2 has a body-centered cubic (bcc) structure, in which equivalent crystal planes represented as [110] planes are preferentially oriented in a direction parallel to the surface of the seed layer 2.

In one embodiment, the lower antiferromagnetic layer 3 and the upper antiferromagnetic layer 9 are formed of antiferromagnetic materials comprising an element X (where the element X is at least one element selected from the group of, for example, Pt, Pd, Ir, Rh, Ru, or Os) and Mn or antiferromagnetic materials containing an element X, an element X′ (where the element X′ is at least one element selected from the group of, for example, Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, or rare earth elements), and Mn.

The lower pinned magnetic layer 4 and the upper pinned magnetic layer 8 are respectively formed as a multilayer of the first pinned magnetic layers (magnetic layers close to the antiferromagnetic layer) 4a and 8a, nonmagnetic intermediate layers 4b and 8b, and the second pinned magnetic layers (magnetic layers close to the nonmagnetic material layer) 4c and 8c.

The lower pinned magnetic layer 4 and the upper pinned magnetic layer 8 have a laminate ferrimagnetic structure. The first pinned magnetic layers 4a and 8a are formed of ferromagnetic materials, for example, CoFe, NiFe, or CoFeNi. The nonmagnetic intermediate layers 4b and 8b are formed of nonmagnetic conductive materials, for example, Ru, Ir, Cr, Re, or Cu. The materials and structures of the second pinned magnetic layers 4c and 8c will be described below.

The lower nonmagnetic material layer 5 and the upper nonmagnetic material layer 7 are formed of, for example, Cu, Au, or Ag.

The material and structure of the free magnetic layer 6 will be described below.

The insulating layers 27 and 29 are formed of insulating materials, for example, Al₂O₃ or SiO₂. The hard bias layer 28 is formed of, for example, a Co—Pt alloy or a Co—Cr—Pt alloy.

The lower shield layer 20 and the upper shield layer 30 are formed of a NiFe alloy or the like.

The spin-valve thin film element shown in FIG. 1 will be described.

In the spin-valve thin film elements shown in FIG. 1, the free magnetic layer 6 and the second pinned magnetic layers 4c and 8c are formed of a CoMnGeSi alloy layer represented by a composition formula of Co₂ₓMnₓ(Ge_{1-z}Si_{z})_{y} (where x and y are atomic percent, and 3x+y=100 atomic percent). The content y in the composition formula is about 23 atomic percent to 26 atomic percent, and a Si ratio Z in GeSi is about 0.1 to 0.6. The ′Si ratio Z′ is represented by atomic percent of Si/(atomic percent of Ge+atomic percent of Si). As a comparative sample for the CoMnGeSi alloy layer, a CoMnGe alloy layer or a CoMnSi alloy is exemplified. Unless otherwise limited, the composition ratio (atomic ratio) of the CoMnGe alloy layer or the CoMnSi alloy layer is Co:Mn:Ge=2:1:1 or Co:Mn:Si=2:1:1.

Composition analysis is performed by SIMS analysis or Nano-beam EDX (Energy Dispersive X-ray Spectroscopy) analysis using a field-emission transmission electron microscope (FE-TEM).

In one embodiment, a product of the amount of a change in magnetoresistance ΔR and an element area A, which is ΔRA, is substantially the same as when the free magnetic layer 6 and the second pinned magnetic layers 4c and 8c are formed of a CoMnGe alloy. In addition, it can be larger than when the free magnetic layer 6 and the second pinned magnetic layers 4c and 8c are formed of a CoMnSi alloy. In this embodiment, specifically, ΔRA of about 8 (MΩμm²) or more can be obtained.

In one embodiment, a coercive force Hc of the free magnetic layer 6 can be reduced compared with a case where the free magnetic layer 6 is formed of a CoMnGe alloy or a CoMnSi alloy. In this embodiment, specifically, a coercive force Hc of 10 Oe (=about 790 A/m) or less can be obtained.

In one embodiment, a coupling magnetic field Hin formed between the pinned magnetic layers 4 and 8 and the free magnetic layer 6 can be reduced compared with a case where the free magnetic layer 6 and the second pinned magnetic layers 4c and 8c are formed of a CoMnGe alloy. In this embodiment, specifically, a coupling magnetic field Hin less than 20 Oe (=about 1580 A/m) can be obtained.

In one embodiment, a unidirectional exchange bias magnetic field (Hex*) can have approximately the same strength as the exchange bias magnetic field between free magnetic layer 6 and the second pinned magnetic layers 4c and 8c formed of a CoMnGe alloy. Further, it can be larger than when the free magnetic layer 6 and the second pinned magnetic layers 4c and 8c formed of a CoMnSi alloy. The unidirectional exchange bias magnetic field (Hex*) is the strength of a magnetic field including an exchange coupling magnetic field formed between the first pinned magnetic layers 4a and 8a and the antiferromagnetic layers 3 and 9 or a coupling magnetic field by an RKKY interaction formed between the first pinned magnetic layers 4a and 8a and the second pinned magnetic layers 4c and 8c. In this embodiment, the unidirectional exchange bias magnetic field (Hex*) can be at least 1000 Oe (about 79 kA/m) or more, and preferably, 1300 Oe (about 102.7 kA/m).

As described above, in this embodiment, the Si ratio Z in GeSi is set in a range of about 0.1 to 0.6. If the Si ratio is larger than 0.6, a crystallization temperature significantly increases (specifically, 300° C. or more). At a temperature of about 290° C. which is a normal annealing temperature on the magnetic detecting element, it is impossible to promote crystallization of the CoMnGeSi alloy layer and regularization of the crystal, which causes a decrease in ΔRA.

In one embodiment, the unidirectional exchange bias magnetic field (Hex*) is decreased if the annealing temperature increases according to the crystallization temperature. Accordingly, in this embodiment, the Si ratio Z is set to about 0.6 or less, and preferably, about 0.4 or less. Accordingly, ΔRA and the unidirectional exchange bias magnetic field (Hex*) can be appropriately set to high values. The coercive force Hc of the free magnetic layer 6 can be reduced. For example, ΔRA of about 9 (MΩcm²) or more can be obtained. Further, the unidirectional exchange bias magnetic field (Hex*) can be 1500 Oe (about 118.5 kA/m) or more. The coercive force Hc of the free magnetic layer 6 can be substantially 0 (zero) Oe, if the Si ratio Z is set to about 0.4.

In this embodiment, the Si ratio Z is preferably set to about 0.25 or more. If the Si ratio Z is set to 0.25 or more, the coercive force Hc of the free magnetic layer 6 and the coupling magnetic field Hin can be appropriately reduced. For example, the coercive force Hc of the free magnetic layer 6 can be 7 Oe (about 553 A/m) or less. The coupling magnetic field Hin can be about 10 Oe (about 790 A/m) or less.

As described above, in this embodiment, the content y is set to about 23 atomic percent to 26 atomic percent, and preferably, the content y is set to about 24.5 atomic percent or more. According to an experiment described below, it can be seen that, if the content y is smaller than 23 atomic percent, ΔRA is likely to be small, and the coercive force Hc of the free magnetic layer 6 is likely to be increased. Accordingly, the content y is set to about 23 atomic percent or more, and preferably, 24.5 atomic percent or more. If the content y is set to 24.5 atomic or more, specifically, ΔRA of about 9 (MmΩμm²) or more can be obtained.

The content y is preferably set to 25.5 atomic percent or less, and more preferably, 25 atomic percent. According to an experiment described below, it can be seen that the coupling magnetic field Hin increases as the content y increases. Accordingly, in order to make the coupling magnetic field Hin as small as possible, the content y is set to 26 atomic percent or less, preferably, 25.5 atomic percent or less, and more preferably, 25 atomic percent or less.

With this configuration, the magnetic detecting element of this embodiment can cope with high recording density. Further, a variation in reproduction output can be reduced, and asymmetry can be favorably maintained. In addition, Barkhausen noise can be reduced, and the S/N ratio can be increased.

The free magnetic layer 6 shown in FIG. 1 is formed as a single layer but may be formed as a laminate of magnetic layers or a laminated ferrimagnetic structure, like the pinned magnetic layers 4 and 8. When the free magnetic layer 6 is formed as a laminate of magnetic layers, for example, the free magnetic layer 6 is formed as a three-layer structure in which a CoMnα alloy layer (where α is at least one element selected from the group of, for example, Ge, Ga, In, Pb, Zn, Sn, or Al), for example, a CoMnGe alloy layer represented by Co₂Mn₁Ge₁ (atomic ratio 2:1:1), is provided between two CoMnGeSi alloy layers.

When the CoMnGeSi alloy layer is used, ΔRA can be obtained equal to when the CoMnGe alloy layer is used. For example, in order to promote the reduction of the coercive force Ha or the coupling magnetic field Hin, for example, if the Si ratio Z is set to about 0.5, the coercive force Hc or the coupling magnetic field Hin can be preferably reduced, but ΔRA is likely to slightly decrease compared with a case where the CoMnGe alloy is used. Therefore, if the CoMnGe alloy layer is provided in a portion of the free magnetic layer 6, high ΔRA can be stably obtained. Further, in addition to the CoMnα alloy layer, a ferromagnetic material layer, such as NiFe, CoFeNi, CoFe, or the like, may be used. For example, a laminate of CoMnGeSi/NiFe/CoMnGeSi or a laminate of CoFe/CoMnGeSi/CoFe may be used. Moreover, the free magnetic layer 6 may be a two-layer structure or a four or more-layer structure, instead of a three-layer structure.

In FIG. 1, the second pinned magnetic layers 4c and 8c constituting the pinned magnetic layers 4 and 8 are formed as a single layer of the CoMnGeSi alloy layer. If the CoMnGeSi alloy layer is used as the second pinned magnetic layers 4c and 8c, a high ΔRA can be obtained. The coupling magnetic field Hin can be appropriately reduced. Therefore, when the free magnetic layer 6 is formed as a laminated ferrimagnetic structure, the magnetic layers close to the nonmagnetic material layers 5 and 7 are preferably formed of the CoMnGeSi alloy layer. For example, the free magnetic layer 6 is formed as a laminate ferrimagnetic structure of the CoMnGeSi alloy layer/Ru/the CoMnGeSi alloy layer.

The second pinned magnetic layers 4c and 8c may be formed as a laminate of magnetic layers. In this embodiment, preferably, of the second pinned magnetic layers 4c and 8c, a magnetic layer close to the nonmagnetic material layers 5 and 7 is formed of the CoMnGeSi alloy layer, and a magnetic layer close to the nonmagnetic intermediate layers 4b and 8b is formed of a magnetic layer other than the CoMnGeSi alloy layer. For example, as the magnetic layer close to the nonmagnetic intermediate layers 4b and 8b of the second pinned magnetic layers 4c and 8c, a ferromagnetic material layer, for example, NiFe, CoFeNi, or CoFe, is provided.

In one embodiment, the RKKY interaction formed between the first pinned magnetic layers 4a and 8a can be increased, and the second pinned magnetic layers 4c and 8c can be solidly magnetized and pinned together with the first pinned magnetic layers 4a and 8a. Moreover, as a magnetic layer other than the CoMnGeSi alloy layer, the above-described CoMnα alloy layer (where α is at least one element selected from the group of, for example, Ge, Ga, In, Pb, Zn, Sn, or Al) may be used. In addition, when the free magnetic layer 6 is formed as the laminated ferrimagnetic structure, instead of the structure of the CoMnGeSi alloy layer/Ru/the CoMnGeSi alloy layer, the upper and lower magnetic layers with Ru interposed therebetween can be respectively formed as a multilayer structure of magnetic layers including the CoMnGeSi alloy layer. As the magnetic layer other than the CoMnGeSi alloy layer used at that time, the above-described CoMnα alloy layer (where α is at least one element selected from the group of, for example, Ge, Ga, In, Pb, Zn, Sn, or Al) or a ferromagnetic material layer, for example, NiFe, CoFeNi, or CoFe may be used.

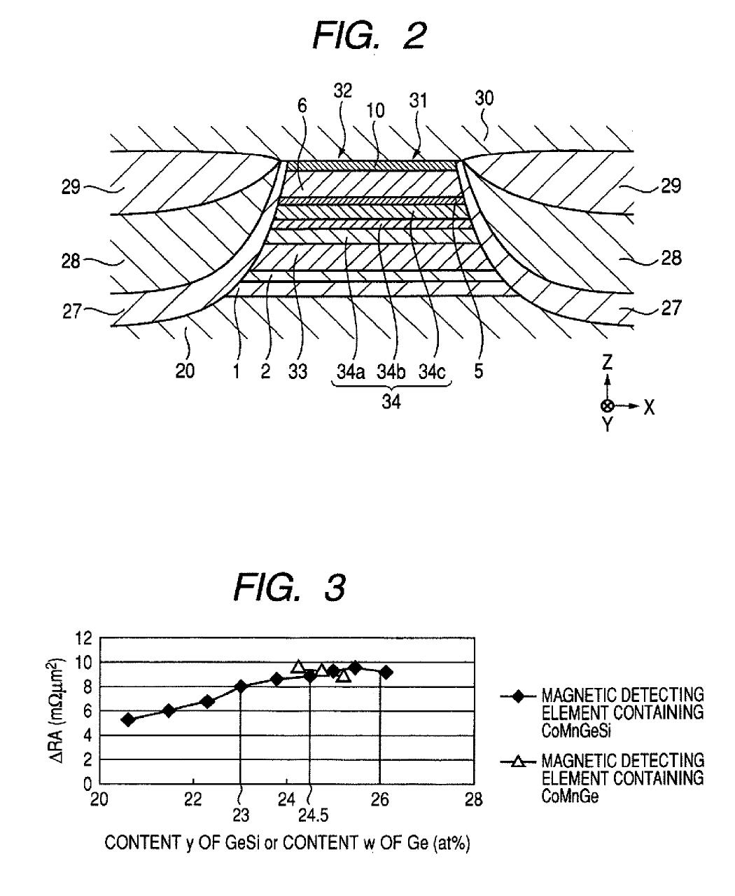

FIG. 2 a partial cross-sectional view that shows one embodiment of a CPP-type single spin-valve thin film element (magnetic detecting element).

In one embodiment, as shown in FIG. 2, a single spin-valve thin film element 31 is formed between the lower shield layer 20 and the upper shield layer 30. The single spin-valve thin film element 31 has a laminate 32 that has a base layer 1, a seed layer 2, an antiferromagnetic layer 33, a pinned magnetic layer 34, a nonmagnetic material layer 35, a free magnetic layer 6, and a protective layer 10 laminated in that order from the below. The pinned magnetic layer 34 has a first pinned magnetic layer 34a, a nonmagnetic intermediate layer 34b, and a second pinned magnetic layer 34c laminated in that order from the below. The material of each layer is as described with reference to FIG. 1.

In one embodiment of the single spin-valve thin film element 31, the free magnetic layer 6 and the second pinned magnetic layer 34c are formed of a CoMnGeSi alloy layer represented by a composition formula of a composition formula of Co₂ₓMnₓ(Ge_{1-z}Si_{z})_{y} (where x and y are atomic percent, and 3x+y=100 atomic percent). The content y in the composition formula is 23 atomic percent to about 26 atomic percent, and the Si ratio Z in GeSi is about 0.1 to 0.6.

With this configuration, ΔRA that substantially has the same strength as the free magnetic layer 6 and the second pinned magnetic layer 34c formed of a CoMnGe alloy layer can be obtained. It can also be larger than when the free magnetic layer 6 and the second pinned magnetic layer 34c are formed of a CoMnSi alloy layer.

The coercive force Hc of the free magnetic layer 6 can be reduced compared with the free magnetic layer 6 that is formed of a CoMnGe alloy or a CoMnSi alloy.

The coupling magnetic field Hin formed between the pinned magnetic layer 34 and the free magnetic layer 6 can be reduced compared with a case the free magnetic layer 6 and the second pinned magnetic layer 34c are formed of the CoMnGe alloy.

In addition, the unidirectional exchange bias magnetic field (Hex*) can have approximately the same strength as the exchange bias magnetic field between free magnetic layer 6 and the second pinned magnetic layer 34c formed of the CoMnGe alloy can be obtained. It can also be larger than when the free magnetic layer 6 and the second pinned magnetic layer 34c are formed of the CoMnSi alloy.

In one embodiment, the magnetic detecting element can cope with high recording density. A variation in reproduction output can be made small, and asymmetry can be favorably maintained. In addition, Barkhausen noise can be reduced, and the S/N ratio can be increased.

Moreover, since a preferable range (a limited range) of the content y or the Si ratio Z is as described with reference to FIG. 1, the description of FIG. 1 may be referred to therefor.

A method of manufacturing the dual spin-valve thin film element 21 shown in FIG. 1 will be described. The base layer 1, the seed layer 2, the lower antiferromagnetic layer 3, the lower pinned magnetic layer 4, the lower nonmagnetic material layer 5, the free magnetic layer 6, the upper nonmagnetic material layer 7, the upper pinned magnetic layer 8, the upper antiferromagnetic layer 9, and the protective layer 10 are formed by a sputtering method or a deposition method. Since the material of each layer is as described with reference to FIG. 1, the description of FIG. 1 may be referred to therefor.

In one embodiment, as shown in FIG. 1, the free magnetic layer 6 and the second pinned magnetic layers 4c and 8c are formed of the CoMnGeSi alloy layer represented by the composition formula of the composition formula of Co₂ₓMnₓ(Ge_{1-z}Si_{z})_{y} (where x and y are atomic percent, and 3x+y=100 atomic percent) by a sputtering method. The content y in the composition formula is between about 23 atomic percent to 26 atomic percent, and the Si ratio Z is between about 0.1 to 0.6.

After the base layer 1 to the protective layer 10 are laminated, an annealing treatment is performed (for example, at 290° C. for three to four hours). An exchange coupling magnetic field is formed at the interfaces between the antiferromagnetic layers 3 and 9 and the first pinned magnetic layers 4a and 8a constituting the pinned magnetic layers 4 and 8, and then the first pinned magnetic layers 4a and 8a are magnetized in a direction parallel to the height direction (in the drawing, the Y direction). The RKKY reaction occurs between the first pinned magnetic layers 4a and 8a and the second pinned magnetic layers 4c and 8c, and then the second pinned magnetic layers 4c and 8c are magnetized in a direction antiparallel to the magnetization direction of the first pinned magnetic layers 4a and 8a.

Even at the above-described annealing temperature of about 290° C., crystallization and regularization of the CoMnGeSi alloy layer and regularization can be further appropriately promoted. According to this embodiment, if the CoMnGeSi alloy layer that has the above-described composition is used, the crystallization temperature of the CoMnGeSi alloy layer can be made lower than 300° C., and preferably, can reliably become 290° C. or less. Therefore, like the related art, even at the annealing temperature of about 290° C., crystallization and regularization of the CoMnGeSi alloy layer can be further appropriately promoted.

After the laminate 22 is formed in a shape shown in the drawing, the insulating layer 27, the hard bias layer 28 and the insulating layer 29 are formed on both sides of the laminate 22 in the track width direction from the below by a sputtering method or a deposition method. The hard bias layer 28 is magnetized in the X direction of the drawing, and the magnetization direction of the free magnetic layer 6 is aligned in the X direction of the drawing.

The single spin-valve thin film element 31 shown in FIG. 2 can also be formed by the same manufacturing method as the dual spin-valve thin film element shown in FIG. 1.

A dual spin-valve thin film element that has the following basic layer configuration was manufactured.

The basic layer configuration was as follows: the base layer 1; Ta(30)/the seed layer 2; NiFeCr(50)/the lower antiferromagnetic layer 3; IrMn(70)/the lower pinned magnetic layer 4 [the first pinned magnetic layer 4a; Fe_{30at %}Co_{70at %}(30)/the nonmagnetic intermediate layer 4b; Ru(9.1)/the second pinned magnetic layer 4c]/the lower nonmagnetic material layer 5; Cu(50)/the free magnetic layer 6/the upper nonmagnetic material layer 7; Cu(50)/the upper pinned magnetic layer 8 [the second pinned magnetic layer 8c/the nonmagnetic intermediate layer 8b; Ru(9.1)/the first pinned magnetic layer 8a; Fe_{40at %}Co_{60at %}(30)/the upper antiferromagnetic layer 9; IrMn(70)/the protective layer 10; Ta(200). Moreover, each numeric value in parenthesis represents a thickness and the unit is Å.

In one experiment, the free magnetic layer 6 was formed of a CoMnGeSi alloy layer represented by a composition formula of a composition formula of Co₂ₓMnₓ(Ge_{0.75}Si_{0.25})_{y} (where 3x+y=100% by mass). The thickness of the free magnetic layer 6 was set to 40 Å.

The second pinned magnetic layers 4c and 8c were formed as a laminate of Fe_{49at %}Co_{60at %} and the CoMnGeSi alloy layer represented by the composition formula of Co₂ₓMnₓ(Ge_{0.75}Si_{0.25})_{y} (where 3x+y=100% by mass). The CoMnGeSi alloy layer was formed on a side close to the nonmagnetic material layers 8 and 7. The thickness of the FeCo alloy layer was set to 10 Å, and the thickness of the CoMnGeSi alloy layer was 40 Å.

In the experiment, a plurality of dual spin-valve thin film elements (hereinafter, the dual spin-valve thin film element is referred to as a magnetic detecting element containing CoMnGeSi) that has different contents y were formed, and the annealing treatment was performed on the individual magnetic detecting elements containing CoMnGeSi at 290° C. for three hours and 40 minutes.

The free magnetic layer 6 of the above-described basic layer configuration was formed of a CoMnGe alloy layer represented by Co₂ₓMnₓGe_{w} (where 3x+w=100% by mass). The thickness of the free magnetic layer 6 was set to 40 Å.

The second pinned magnetic layers 4c and 8c were formed of a laminate of Fe_{40at %}Co_{60at %} and the CoMnGe alloy represented by the composition formula of Co₂ₓMnₓGe_{w} (3x+w=100% mass). The CoMnGe alloy layer was formed on a side close to the nonmagnetic material layers 5 and 7. The thickness of the FeCo alloy layer was set to 10 Å, and the thickness of the CoMnGeSi alloy layer was set to 40 Å.

In the experiment, a plurality of dual spin-valve thin film elements (hereinafter, the dual spin-valve thin film element were referred to as a magnetic detecting element containing CoMnGe) having different contents w are formed, and the annealing treatment was performed on the individual magnetic detecting elements containing CoMnGe at 290° C. for three hours and 40 minutes.

The individual magnetic detecting elements containing CoMnGeSi and the individual magnetic detecting elements containing CoMnGe, ΔRA was measured. The element area A was set to 0.12 μm^{2.} FIG. 3 is a graph showing the relationship between the content y of GeSi of a magnetic detecting element containing CoMnGeSi and ΔRA and the relationship between the content w of Ge of a magnetic detecting element containing CoMnGe and ΔRA.

As shown in FIG. 3, if the content y of GeSi is set to 23 atomic percent to 26 atomic percent, ΔRA substantially identical with ΔRA of the magnetic detecting element containing CoMnGe can be obtained, and ΔRA of 8 (mΩμm²) or more can be obtained. As shown in FIG. 3, if the content y of GeSi is set to 24.5 atomic percent or more, ΔRA of 9 (MΩμm²) can be obtained.

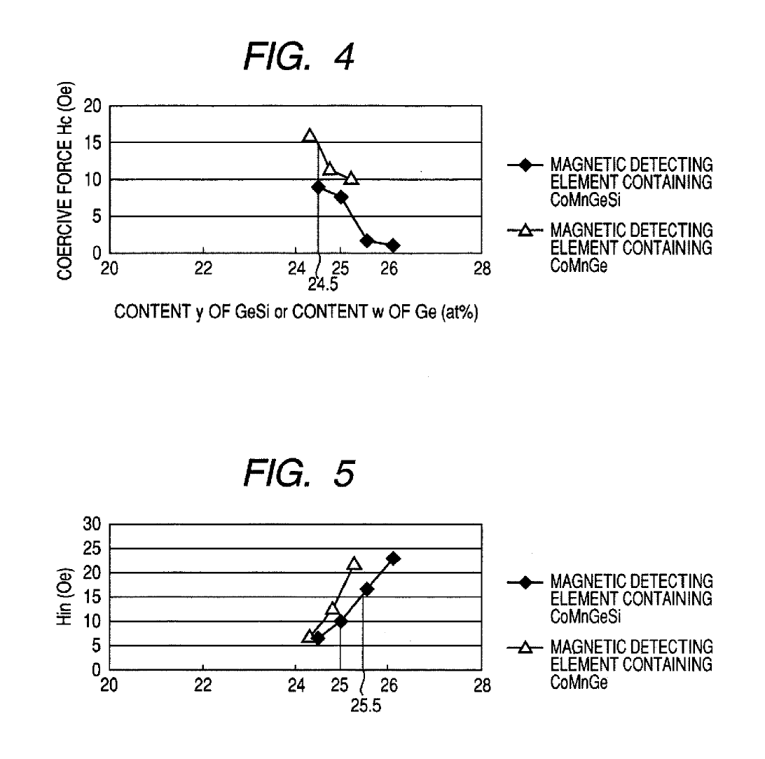

In the experiment, for the individual magnetic detecting elements containing CoMnGeSi and the individual magnetic detecting elements containing CoMnGe, the coercive force Hc of the free magnetic layer was measured by a vibrating sample magnetometer (VSM). FIG. 4 is a graph showing the relationship between the content y of GeSi of a magnetic detecting element containing CoMnGeSi and a coercive force Ha and the relationship between the content w of Ge of a magnetic detecting element containing CoMnGe and the coercive force Hc.

As shown in FIG. 4, if the content y of GeSi increases, the coercive force Hc tends to decrease. If the content y of GeSi is set to 24.5 atomic percent or more, the coercive force Hc of the free magnetic layer of the magnetic detecting element containing CoMnGeSi can be made smaller than the coercive force Ha of the free magnetic layer of the magnetic detecting element containing CoMnGe, and specifically, can be made 10 Oe (about 790 A/m) or less. For example, if the content y of GeSi is 25 atomic percent or more, the coercive force Ha can be made 7 Oe (about 553 A/m) or less.

In the experiment, for the individual magnetic detecting elements containing CoMnGeSi and the individual magnetic detecting elements containing CoMnGe, the coupling magnetic field Hin was measured by the vibrating sample magnetometer (VSM). FIG. 5 is a graph showing the relationship between the content y of GeSi of a magnetic detecting element containing CoMnGeSi and a coupling magnetic field Hin and the relationship between the content w of Ge of a magnetic detecting element containing CoMnGe and a coupling magnetic field Hin.

As shown in FIG. 5, if the content y of GeSi is made small, the coupling magnetic field Hin tends to decrease. If the content y of GeSi is 26 atomic percent or less, the coupling magnetic field Hin of the magnetic detecting element containing CoMnGeSi can be made smaller than the coupling magnetic field Hin of the magnetic detecting element containing CoMnGe, and specifically, can be smaller than 20 Oe (about 1580 A/m). For example, if the content y of GeSi is set to 25.5 atomic percent or less, the coupling magnetic field Hin can be 15 Oe (about 1185 A/m) or less. In addition, if the content y of GeSi is set to 25 atomic percent or less, the coupling magnetic field Hin can be 10 Oe (about 790 A/m).

From the experiment results of FIGS. 3 to 5, the content y of GeSi was set to 23 atomic percent to 26 atomic percent. A lower limit value was preferably set to 24.5 atomic percent, and an upper limit value was preferably set to 25.5 atomic percent and more preferably, 25 atomic percent.

A dual spin-valve thin film element having the following basic layer configuration was manufactured.

The basic layer configuration was as follows: the base layer 1; Ta(30)/the seed layer 2; NiFeCr(50)/the lower antiferromagnetic layer 3; IrMn(70)/the lower pinned magnetic layer 4 [the first pinned magnetic layer 4a; Fe_{30at %}Co_{70at %}(30)/the nonmagnetic intermediate layer 4b; Ru(9.1)/the second pinned magnetic layer 4c]/the lower nonmagnetic material layer 5; Cu(50)/the free magnetic layer 6/the upper nonmagnetic material layer 7; Cu(50)/the upper pinned magnetic layer 8 [the second pinned magnetic layer 8c/the nonmagnetic intermediate layer 8b; Ru(9.1)/the first pinned magnetic layer 8a; Fe_{40at %}Co_{60at %}(30)/the upper antiferromagnetic layer 9; IrMn(70)/the protective layer 10; Ta(200). The numeric values in parenthesis represent a thickness and the unit is Å.

In the experiment, the free magnetic layer 6 was formed of a CoMnGeSi alloy layer represented by a composition formula of Co_{50at %}Mn_{25at %}(Ge_{1-z}Si_{z})_{25at %}. The thickness of the free magnetic layer 6 was set to 40 Å.

The second pinned magnetic layers 4c and 8c were formed of a laminate of Fe_{40at %}Co_{60at %} and the composition formula of Co_{60at %}Mn_{25at %}(Ge_{1-z}Si_{z})_{25at %}. The CoMnGeSi alloy layer was formed on a side close to the nonmagnetic material layers 5 and 7. The thickness of the FeCo alloy layer was set to 10 Å, and the thickness of the CoMnGeSi alloy layer was set to 40 Å.

In the experiment, a plurality of dual spin-valve thin film elements (hereinafter, the dual spin-valve thin film element is referred to as a magnetic detecting element containing CoMnGeSi) that has different Si ratios z were formed, and the annealing treatment was performed on the individual magnetic detecting elements containing CoMnGeSi at 290° C. for three hours and 40 minutes.

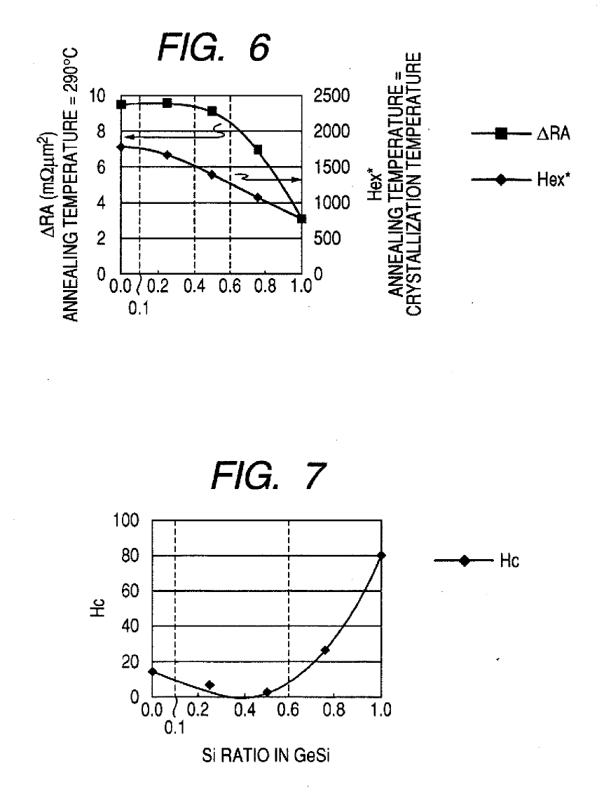

The individual magnetic detecting elements containing CoMnGeSi, ΔRA was measured. Moreover, the element area A was set to 0.12 μm². FIG. 6 shows the relationship between the Si ratio Z and ΔRA.

In the experiment, for the individual magnetic detecting elements containing CoMnGeSi, the unidirectional exchange bias magnetic field (Hex*) was measured. The annealing temperature upon the measurement was a temperature according to the crystallization temperature of each CoMnGeSi alloy layer.

TABLE 1

| | | Hex* (Oe) | | | |
|---|---|---|---|---|---|
| | | (Annealing | ΔRA (mΩμm²) | | |
| | Crystallization | Temperature = | (Annealing | Hc (Annealing | Hin (Annealing |
| | Temperature | Crystallization | Temperature = | Temperature = | Temperature = |
| Si Ratio Z | (° C.) | Temperature) | 290° C.) | 290° C.) | 290° C.) |
| 0.00 | 250 | 1800 | 9.5 | 12.0 | 20.0 |
| 0.25 | 270 | 1680 | 9.5 | 7.0 | 10.0 |
| 0.50 | 290 | 1420 | 9.1 | 1.5 | 5.0 |
| 0.75 | 310 | 1050 | 7.0 | 27.0 | 2.0 |
| 1.00 | 330 | 750 | 3.0 | 80.0 | 0.0 |

As shown in TABLE 1, if the Si ratio Z increases, the crystallization temperature rises. Accordingly, when the annealing treatment is performed on the individual magnetic detecting elements containing CoMnGeSi, the annealing treatment was performed at the same temperature as the crystallization temperature, and then the unidirectional exchange bias magnetic field (Hex*) was measured for the individual magnetic detecting elements containing CoMnGeSi. FIG. 6 shows the relationship between the Si ratio Z and the unidirectional exchange bias magnetic field (Hex*).

As shown in FIG. 6, if the Si ratio Z increases, ΔRA is reduced. As shown in FIG. 6, if the Si ratio Z is in a range of 0.1 to 0.6, it can be seen that ΔRA can be 8 (μΩcm²). Further, since ΔRA is likely to be reduced if the Si ratio Z is larger than 0.4, it can be seen that the Si ratio Z is preferably 0.4 or less. It can be seen that ΔRA can be 9 (μΩcm²) or more.

As described above, the reason why ΔRA is reduced as the Si ratio Z increases is that the crystallization temperature rises as the Si ratio Z increases, as shown in Table 1, and crystallization and regularization of the CoMnGeSi alloy layer having the crystallization temperature of 290° C. is not appropriately performed at the annealing temperature of 290° C. For example, it is considered that, as the Si ratio Z is large (the crystallization temperature is high), ΔRA is reduced.

As shown in FIG. 6, when the Si ratio Z increases, the unidirectional exchange bias magnetic field (Hex*) is reduced. In the experiment of the unidirectional exchange bias magnetic field (Hex*), since the annealing temperature is adjusted to the crystallization temperature, it is considered that each CoMnGeSi alloy layer is appropriately crystallized. However, if the Si ratio Z increases (as the annealing temperature is made high according to the rise of the crystallization temperature due to the increase in the Si ratio Z), the unidirectional exchange bias magnetic field (Hex*) is reduced. As shown in FIG. 6, if the Si ratio Z is set in a range of 0.1 to 0.6, the unidirectional exchange bias magnetic field (Hex*) of at least 1000 Oe (about 79 kA/m) or more, and preferably, 1300 Oe (about 102.7 kA/m) can be obtained. In addition, if the Si ratio Z is set to 0.4 or less, the unidirectional exchange bias magnetic field (Hex*) of 1500 Oe (about 118.5 kA/m) can be obtained.

In the experiment, for the individual magnetic detecting elements containing CoMnGeSi, the coercive force Hc of the free magnetic layer was measured by the vibrating sample magnetometer (VSM). Moreover, for the individual magnetic detecting elements containing CoMnGeSi, the annealing temperature was the same, for example, 290° C. FIG. 7 shows the relationship between the Si ratio Z and the coercive force Hc. Moreover, the relationship between the Si ratio Z and the coercive force Hc is also shown in Table 1.

As shown in FIG. 7, when the Si ratio Z is about 0.4, the coercive force Hc becomes 0 Oe, and, when the Si ratio Z is made smaller than 0.4 or larger than 0.4, the coercive force Hc gradually increases. For example, if the Si ratio Z is made larger than 0.4, the coercive force Hc exponentially rises compared with a case where the Si ratio Z is made smaller than 0.4. As shown in FIG. 7, if the Si ratio Z is set in a range of 0.1 to 0.6, the coercive force Hc can be suppressed to 10 Oe (about 790 A/m) or less. Preferably, the lower limit value of the Si ratio z is set to 0.25 and the upper limit value of the Si ratio z is set to 0.4 or less. Accordingly, it can be seen that the coercive force Hc can be suppressed to 7 Oe (about 553 A/m) or less.

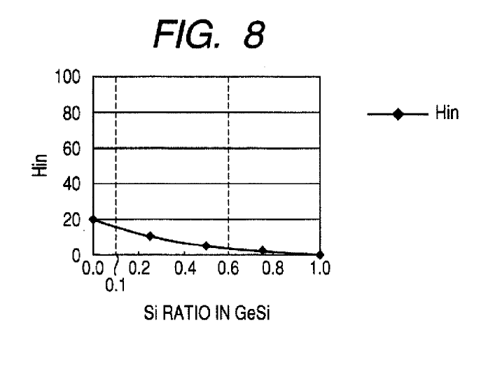

In the experiment, for the individual magnetic detecting elements containing CoMnGeSi, the coupling magnetic field Hin was measured by the vibrating sample magnetometer (VSM) Moreover, for the individual magnetic detecting element containing CoMnGeSi, the annealing temperature was the same, for example, 290° C. FIG. 8 shows the relationship between the Si ratio Z and the coupling magnetic field Hin. Moreover, the relationship between the Si ratio Z and the coupling magnetic field Hin is shown in Table 1.

As shown in FIG. 8, if the Si ratio Z increases, the coupling magnetic field Hin is gradually made small. As shown in FIG. 8, if the Si ratio Z is set in a range of 0.1 to 0.6, the coupling magnetic field Hin can be made smaller than 20 Oe (about 1580 A/m). Preferably, the lower limit value of the Si ratio Z is set to 0.25. The coupling magnetic field Hin can be suppressed to 10 Oe (about 790 A/m) or less.

From the experiment results of FIGS. 6 to 8, the Si ratio Z was set in the range of 0.1 to 0.6. Preferably, the lower limit value of the Si ratio Z was set to 0.25 and the upper limit value of the Si ratio Z was set to 0.4.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A magnetic detecting element comprising:
a pinned magnetic layer that includes a pinned magnetization direction; and
a free magnetic layer that is formed on the pinned magnetic layer with a nonmagnetic material layer interposed therebetween and in which a magnetization direction is changed by an external magnetic field,
wherein the free magnetic layer, the pinned magnetic layer, or both have a CoMnGeSi alloy layer represented by a composition formula of C₂ₓMnₓ(Ge_{1-z}Si_{z})_{y} (where x and y are atomic percent, and 3x+y=100 atomic percent), and
the content y is between about 23 atomic percent to 26 atomic percent, and a Si ratio Z in GeSi is about 0.1 to 0.6.

2. The magnetic detecting element according to claim 1, wherein the Si ratio Z is 0.4 or less.

3. The magnetic detecting element according to claim 1, wherein the Si ratio Z is 0.25 or more.

4. The magnetic detecting element according to claim 2, wherein the Si ratio Z is 0.25 or more.

5. The magnetic detecting element according to claim 1, wherein the CoMnGeSi alloy is formed close to at least the nonmagnetic material layer.

6. The magnetic detecting element according to claim 2, wherein the CoMnGeSi alloy is formed close to at least the nonmagnetic material layer.

7. The magnetic detecting element according to claim 4, wherein the CoMnGeSi alloy is formed close to at least the nonmagnetic material layer.

8. A method of manufacturing a magnetic detecting element, comprising:
forming a pinned magnetic layer by a sputtering method or a deposition method, the pinned magnetic layer having a pinned magnetization direction;
forming a free magnetic layer on the pinned magnetic layer by a sputtering method or a deposition method;
interposing a nonmagnetic material layer between the pinned magnetic layer and the free magnetic layer, magnetization direction is changed by an external magnetic field,
forming the free magnetic layer, the pinned magnetic layer, or both have a CoMnGeSi alloy layer represented by a composition formula of Co₂ₓMnₓ(Ge_{1-z}Si_{z})_{y} (where x and y are atomic percent, and 3x+y=100 atomic percent), and wherein the content y is between about 23 atomic percent to 26 atomic percent, and a Si ratio Z in GeSi is about 0.1 to 0.6.

9. The method of manufacturing a magnetic detecting element according to claim 8, comprising:
forming a laminate comprising a base layer, a seed layer, a lower antiferromagnetic layer, a lower pinned magnetic layer, a lower nonmagnetic material layer, the upper nonmagnetic material layer, a upper pinned magnetic layer, a upper antiferromagnetic layer, and a protective layer.

10. The method of manufacturing a magnetic detecting element according to claim 9, comprising:
performing an annealing treatment.

11. The method of manufacturing a magnetic detecting element according to claim 10, comprising:
performing an annealing treatment at 290° C. for approximately three to four hours.

12. The method of manufacturing a magnetic detecting element according to claim 10, comprising:
forming an exchange coupling magnetic field at interfaces between the upper and lower antiferromagnetic layers and the upper and lower pinned magnetic layers, and
magnetizing the first pinned magnetic layers in a direction parallel to the height direction.

13. The method of manufacturing a magnetic detecting element according to claim 10, comprising:
forming the laminate in a trapezoidal shape.

14. The method of manufacturing a magnetic detecting element according to claim 9, comprising:
forming an insulating layer, a hard bias layer, and an insulating layer on both sides of the laminate in the track width direction from the below by a sputtering method or a deposition method.
